(19) United States
(12) Patent Application Publication
(10) Pub. No.: US 2015/0214748 A1
(43) Pub. Date: Jul. 30, 2015

(54) WIRELESS POWER SUPPLY SCHEME CAPABLE OF DYNAMICALLY ADJUSTING OUTPUT POWER OF WIRELESS POWER TRANSMITTER ACCORDING TO VOLTAGE/CURRENT/POWER INFORMATION OF PORTABLE ELECTRONIC DEVICE TO BE CHARGED

(71) Applicant: MEDIATEK INC., Hsin-Chu (TW)

(72) Inventors: Hung-Chih Lin, Yunlin County (TW); Pi-Fen Chen, Hsinchu County (TW); Yen-Hsun Hsu, Hsinchu County (TW)

(21) Appl. No.: 14/602,280

(22) Filed: Jan. 22, 2015

Related U.S. Application Data
(60) Provisional application No. 61/931,081, filed on Jan. 24, 2014.

(51) Int. Cl. H02J 5/00; H02J 17/00; H02J 7/02

(52) U.S. Cl. CPC H02J 5/005; H02J 7/025; H02J 17/00

(57) ABSTRACT

A wireless power supplying system includes a wireless power transmitter and a portable electronic device. The wireless power transmitter is arranged for supplying an output power via wireless communication. The portable electronic device is electrically coupled to the wireless power transmitter and used for transmitting at least one of voltage/current/power information associated with the portable electronic device from the portable electronic device back to the wireless power transmitter, so as to make the wireless power transmitter adjust and supply the output power according to the at least one of voltage/current/power information associated with the portable electronic device.

### CROSS REFERENCE TO RELATED APPLICATIONS

This application claims the benefit of U.S. Provisional Application No. 61/931,081, which was filed on Jan. 24, 2014.

### BACKGROUND

The invention relates to a wireless power supplying scheme, and more particularly to a wireless power supplying system, corresponding portable electronic device, and method.

A wireless power charger is now becoming a blooming appliance product for charging portable devices such as cell phones, wearable devices, and touch pads, etc . . . Unfortunately, the output power capability of a conventional wireless power charger may be limited due to efficiency degradation and thermal budgets. This would lead to un-satisfied user experiences. When a conventional portable electronic device approaches to the conventional wireless power charger, the conventional wireless power charger may be arranged to do the best to charge the conventional wireless power charger by wireless power transferring. However, the conventional wireless power charger may be arranged to charge two or more conventional portable electronic devices simultaneously. For example, in a coffee shop, the conventional wireless power charger is used for providing wireless power for customers' devices when the customers visit the coffee shop. It is difficult for the conventional wireless power charger to decide how to charge customers' devices so as to rapidly charge the electronic devices for reducing the whole charging time period of a conventional wireless power system. In addition, a power management scheme for wireless power charging so far is very rare.

### SUMMARY

It is therefore one of the objectives of the invention to provide a scheme and a wireless power supplying system in which voltage/current/power information of a portable electronic device is transmitted to a wireless power transmitter so as to make the wireless power transmitter adjust its output power, to solve the above-mentioned problems.

According to an embodiment of the invention, a wireless power supplying system is disclosed. The wireless power supplying system comprises a wireless power transmitter and a portable electronic device. The wireless power transmitter is used for supplying an output power via wireless communication. The portable electronic device is electrically coupled to the wireless power transmitter and used for transmitting at least one of voltage/current/power information associated with the portable electronic device from the portable electronic device back to the wireless power transmitter, so as to make the wireless power transmitter adjust and supply the output power according to the at least one of voltage/current/power information associated with the portable electronic device.

According to an embodiment of the invention, a method applied to a portable electronic device is disclosed. The method comprises: receiving an output power of a wireless power transmitter via wireless communication; transmitting at least one of voltage/current/power information associated with the portable electronic device from the portable electronic device back to the wireless power transmitter, so as to make the wireless power transmitter adjust and supply the output power according to the at least one of voltage/current/power information associated with the portable electronic device.

According to an embodiment of the invention, a method applied to a wireless power transmitter of a wireless power supplying system is disclosed. The method comprises: receiving at least one of voltage/current/power information from a portable electronic device sent back to the wireless power transmitter, the at least one of voltage/current/power information is associated with the portable electronic device; and adjusting and supplying an output power of the wireless power transmitter according to the at least one of voltage/current/power information.

According to an embodiment of the invention, a portable electronic device is disclosed. The portable electronic device comprises a wireless power receiver and a battery. The wireless power receiver is used for receiving an output power of a wireless power transmitter via wireless communication. The battery is coupled to the wireless power receiver. The wireless power receiver is arranged for transmitting at least one of voltage/current/power information associated with the portable electronic device from the wireless power receiver back to the wireless power transmitter, so as to make the wireless power transmitter adjust and supply the output power according to the at least one of voltage/current/power information.

According to an embodiment of the invention, a wireless power transmitter of a wireless power supplying system is disclosed. The wireless power transmitter comprises a receiving circuit and a power outputting circuit. The receiving circuit is used for receiving at least one of voltage/current/power information from a portable electronic device sent back to the wireless power transmitter, and the at least one of voltage/current/power information is associated with the portable electronic device. The power outputting circuit is coupled to the receiving circuit and used for adjusting and supplying an output power according to the at least one of voltage/current/power information associated with the portable electronic device.

According to the above embodiments, by transmitting voltage/current/power information from a wireless power receiver back to a wireless power transmitter, this can make the wireless power transmitter dynamically adjust its output power level according to the voltage/current/power information. Accordingly, the power efficiency of the whole system can be optimized, and the waiting time period for wireless power charging can be significantly decreased.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a conceptual block diagram of a wireless power supplying system according to embodiments of the invention.

FIGS. 2A-2B, 3A-3B, 4A-4B, 5A-5B, 6A-6B, and 7A-7B are block diagrams of wireless power supplying systems according to different embodiments of the invention.

### DETAILED DESCRIPTION

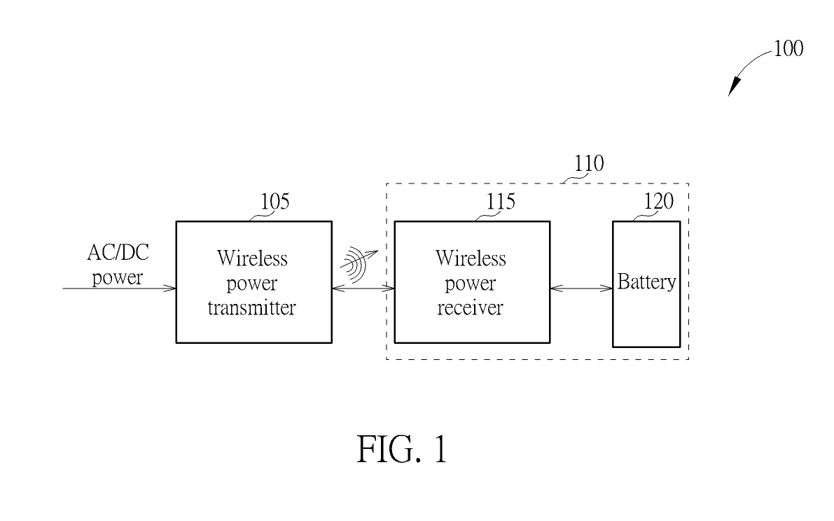

Please refer to FIG. 1, which is a block diagram of a wireless power supplying system 100 according to embodiments of the invention. The wireless power supplying system 100 comprises a wireless power transmitter 105 and a portable electronic device 110 wherein the portable electronic device 110 comprises a wireless power receiver 115 and a battery 120. The wireless power transmitter 105 is used for receiving AC/DC power to provide/supply an output power for the portable electronic device 110 via wireless communication. The wireless power receiver 115 is arranged for receiving the output power of wireless power transmitter 105 and providing/adjusting a corresponding power level for the battery 120 to charge the battery 120. The wireless power transmitter 105 transmits power to the wireless power receiver 115 via wireless resonant/inductive coupling, and the wireless power receiver 115 receives the power to provide a corresponding power to the battery 120 so as to charge the battery 120. The portable electronic device 110 is arranged to sense/detect a condition of the battery 120 and/or to sense/detect a condition of the wireless power receiver 115, to obtain at least one of voltage/current/power information. The portable electronic device 110 transmits the obtained at least one of voltage/current/power information from the wireless power receiver 115 back to the wireless power transmitter 105 via wireless communication. According to the obtained at least one of voltage/current/power information, the wireless power transmitter 105 is able to dynamically adjust and supply its output power.

Specifically, the wireless power transmitter 105 is arranged to dynamically adjust its output power by adjusting the corresponding output voltage or/and the output current. For example, the wireless power transmitter 105 can raise the corresponding output voltage so as to improve the efficiency when charging the battery 120. In addition, the wireless power transmitter 105 may increase the corresponding output current so as to rapidly charge the battery 120. Accordingly, by dynamically adjusting the output voltage and/or output current based on the information from the wireless power receiver 115 and/or battery 120, the power efficiency of wireless power supplying system 100 can be optimized. The wireless power receiver 115 may be arranged to control its output voltage and/or output current for optimizing the power efficiency. In addition, it should be noted that the above-mentioned operations are not intended to be limitations of the invention.

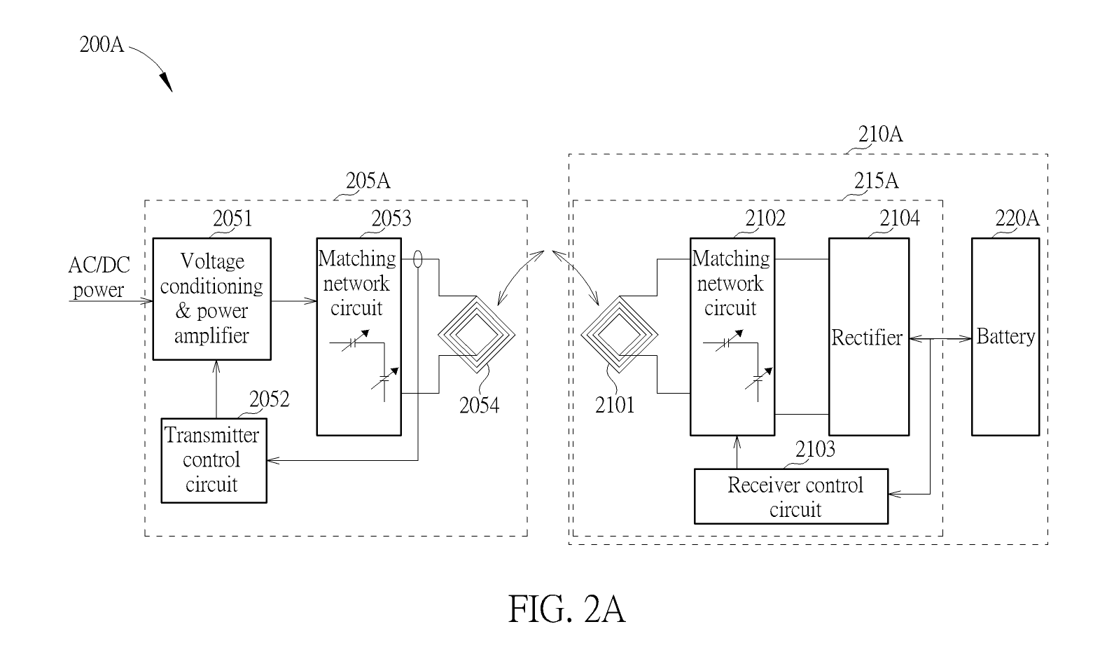

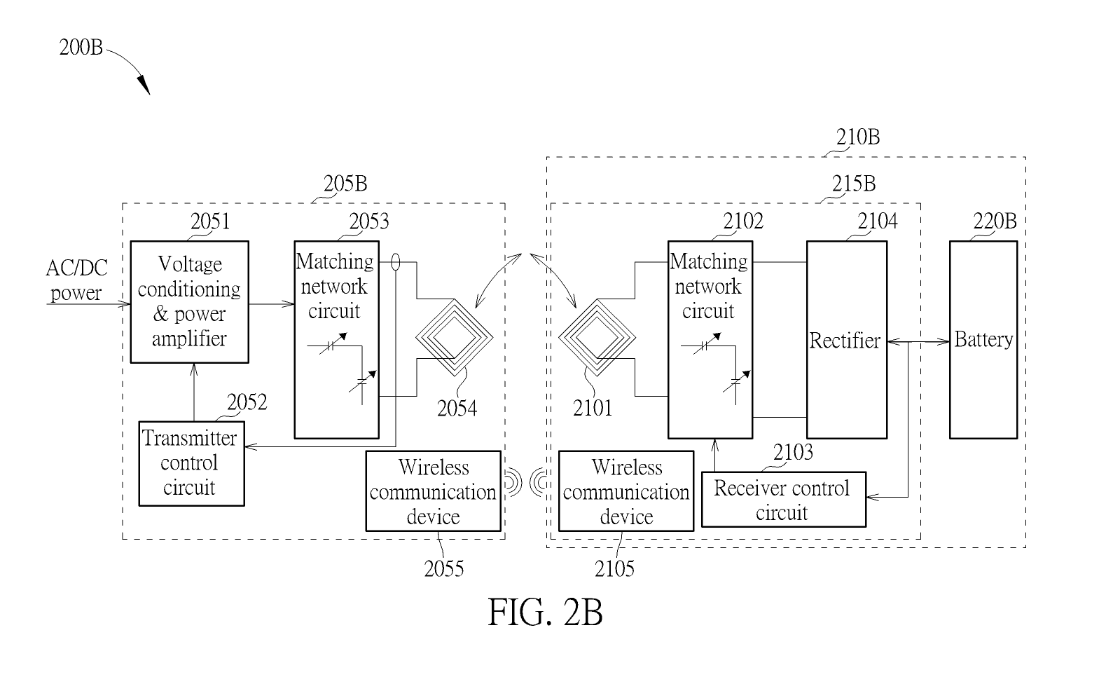

FIG. 2A is a block diagram of a wireless power supplying system 200A according to a first embodiment of the invention. The wireless power supplying system 200A comprises a wireless power transmitter 205A and a portable electronic device 210A including a wireless power receiver 215A and a battery 220A. The operation and function of wireless power transmitter 205A and portable electronic device 210A are similar to those of wireless power transmitter 105 and portable electronic device 110 as shown in FIG. 1. Specifically, the wireless power transmitter 205A comprises a voltage conditioning and power amplifier block 2051, a transmitter control circuit 2052, a matching network circuit 2053, and a coil circuit 2054. The wireless power receiver 210A comprises a coil circuit 2101, a matching network circuit 2102, a receiver control circuit 2103, and a rectifier 2104. The voltage conditioning and power amplifier block 2051 is arranged for receiving input AC/DC power to generate a power signal to the coil circuit 2054 via the matching network circuit 2053. The coil circuit 2054 receives the power signal to generate and output a wireless power signal. The coil circuit 2101 of wireless power receiver 210A is arranged to receive the wireless power signal by resonant or inductive coupling (high Q or low Q) to generate a power signal and transmit the power signal via the matching network circuit 2102 to the rectifier 2104. The rectifier 2104 is arranged to adjust and provide a corresponding voltage signal or current signal to charge the battery 220A according to the received power signal. In this embodiment, voltage/current/power information associated with the battery 220A can be sensed or detected by a circuit within the battery 220A and/or by the wireless power receiver 210A. Alternatively, voltage/current/power information associated with the wireless power receiver 210A can be sensed or detected by the wireless power receiver 210A itself. The wireless power receiver 210A transmits at least one of voltage/current/power information associated with wireless power receiver 210A and/or battery 220A to the wireless power transmitter 205A via in-band wireless communication. Specifically, for example, the sensed voltage/current/power information associated with battery 220A is transmitted to the wireless power receiver 215A via an analog signal interface, a digital signal interface, or a power signal interface, and then the wireless power receiver 215A transmits/transfers the sensed voltage/current/power information to the wireless power transmitter 205A by using a signal having a frequency used in wireless power transmission between wireless power transmitter 205A and wireless power receiver 215A. The transmitter control circuit 2052 detects or senses the voltage/current/power information and accordingly controls the voltage conditioning and power amplifier block 2051 so as to adjust the output power of wireless power transmitter 205A. By exchanging voltage/current/power information between wireless power transmitter 205A and wireless power receiver 215A via in-band wireless communication, the output power of wireless power transmitter 205A can be appropriately adjusted. The power efficiency can be optimized, and the total waiting time period for charging can be decreased.

In addition, exchanging voltage/current/power information between a wireless power transmitter and a wireless power receiver can be achieved via out-band wireless communication. Please refer to FIG. 2B, which is a block diagram of a wireless power supplying system 200B according to a second embodiment of the invention. The wireless power supplying system 200B comprises a wireless power transmitter 205B and a portable electronic device 210B including a wireless power receiver 215B and a battery 220B. The operation and function of wireless power transmitter 205B and portable electronic device 210B are similar to those of wireless power transmitter 105 and portable electronic device 110 as shown in FIG. 1. Specifically, the wireless power transmitter 205B comprises a voltage conditioning and power amplifier block 2051, a transmitter control circuit 2052, a matching network circuit 2053, a coil circuit 2054, and a wireless communication device 2055. The wireless power receiver 215B comprises a coil circuit 2101, a matching network circuit 2102, a receiver control circuit 2103, a rectifier 2104, and a wireless communication device 2105. The wireless power receiver 215B transmits at least one of voltage/current/power information associated with wireless power receiver 215B and/or battery 220B to the wireless power transmitter 205B via out-band wireless communication. For example, the sensed voltage/current/power information associated with battery 220B is transmitted to the wireless power receiver 215B via an analog signal interface, a digital signal interface, or a power signal interface, and then the wireless power receiver 215B transmits/transfers the sensed voltage/current/power information to the wireless power transmitter 205B by using a specific frequency band other than a resonance band of wireless power transmission. Specifically, exchanging voltage/current/power information between wireless power transmitter 205B and wireless power receiver 215B can be executed by the wireless communication devices 2055 and 2105 via the specific frequency band. After receiving the voltage/current/power information, the wireless communication device 2055 transfers the received voltage/current/power information to the transmitter control circuit 2052, and the transmitter control circuit 2052 accordingly controls the voltage conditioning and power amplifier block 2051 so as to adjust the output power of wireless power transmitter 205B. By exchanging voltage/current/power information between wireless power transmitter 205B and wireless power receiver 215B via out-band wireless communication, the output power of wireless power transmitter 205B can be appropriately adjusted. The out-band wireless communication may be implemented by using Bluetooth, Zigbee, WLAN, and/or NFC communication; however, other implementations are not intended to be limitation(s) of the invention.

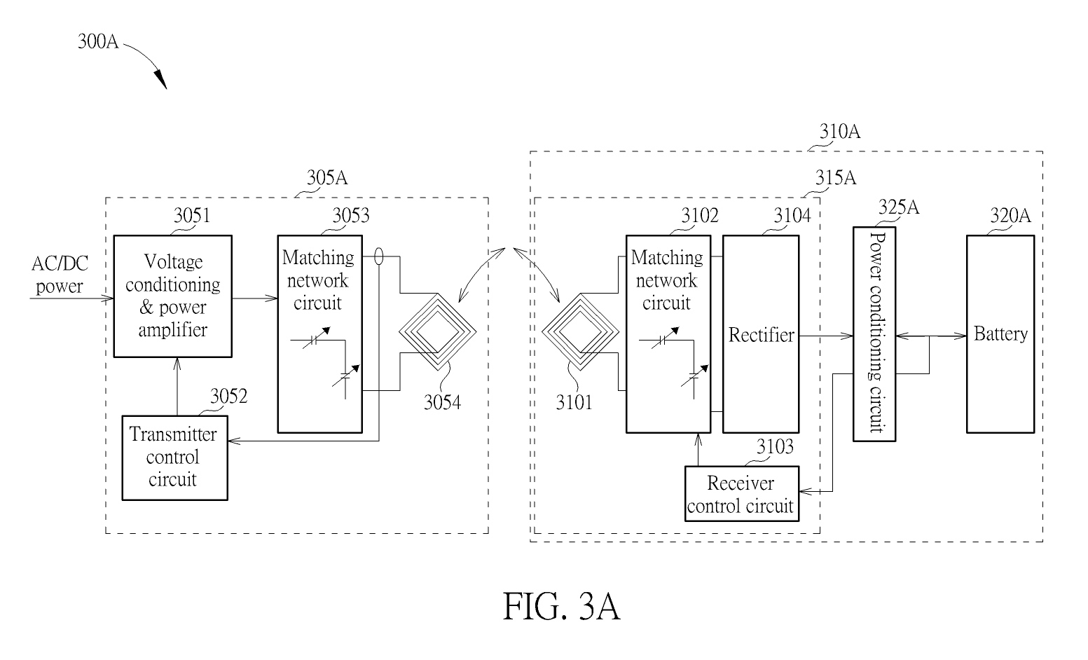

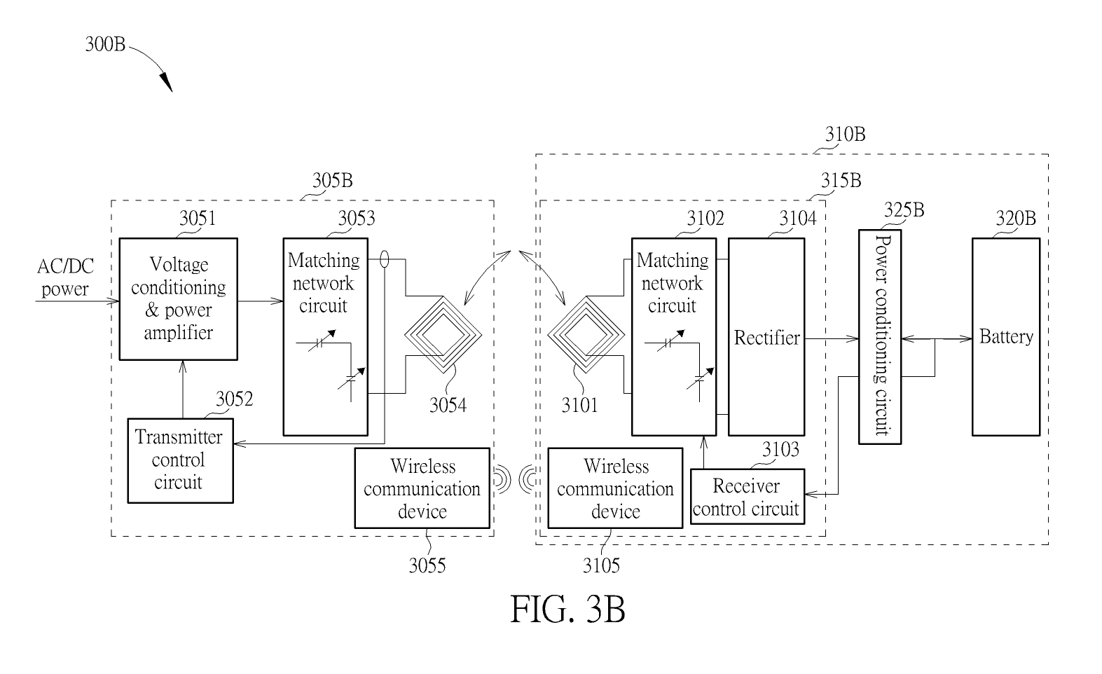

Additionally, other circuit(s) may be installed between a wireless power receiver and a battery included within a portable electronic device. Please refer to FIG. 3A, which is a block diagram of a wireless power supplying system 300A according to a third embodiment of the invention. The wireless power supplying system 300A comprises a wireless power transmitter 305A and a portable electronic device 310A including a wireless power receiver 315A, a battery 320A, and a power conditioning circuit 325A such as a charger coupled between wireless power receiver 315A and battery 320A. The operation and function of wireless power transmitter 305A and portable electronic device 310A are similar to those of wireless power transmitter 105 and portable electronic device 110 as shown in FIG. 1. Specifically, the wireless power transmitter 305A comprises a voltage conditioning and power amplifier block 3051, a transmitter control circuit 3052, a matching network circuit 3053, and a coil circuit 3054. The wireless power receiver 315A comprises a coil circuit 3101, a matching network circuit 3102, a receiver control circuit 3103, and a rectifier 3104. The wireless power receiver 315A transmits at least one of voltage/current/power information associated with wireless power receiver 315A, power conditioning circuit 325A, and/or battery 320A to the wireless power transmitter 305A via in-band wireless communication. For example, the voltage/current/power information associated with battery 320A may be sensed and transmitted to the wireless power receiver 315A via the power conditioning circuit 325A, and then the wireless power receiver 315A transmits/transfers the sensed voltage/current/power information to the wireless power transmitter 305A by using a signal having a frequency used in wireless power transmission between wireless power transmitter 305A and wireless power receiver 315A. The transmitter control circuit 3052 detects or senses the voltage/current/power information and accordingly controls the voltage conditioning and power amplifier block 3051 so as to adjust the output power of wireless power transmitter 305A. By exchanging voltage/current/power information between wireless power transmitter 305A and wireless power receiver 315A via in-band communication, the output power of wireless power transmitter 305A can be appropriately adjusted. The power efficiency can be optimized, and the total waiting time period for charging can be decreased.

Please refer to FIG. 3B, which is a block diagram of a wireless power supplying system 300B according to a fourth embodiment of the invention. The wireless power supplying system 300B comprises a wireless power transmitter 305B and a portable electronic device 310B including a wireless power receiver 315B, a battery 320B, and a power conditioning circuit 325B such as a charger coupled between wireless power receiver 315B and battery 320B. The operation and function of wireless power transmitter 305B and portable electronic device 310B are similar to those of wireless power transmitter 105 and portable electronic device 110 as shown in FIG. 1. Specifically, the wireless power transmitter 305B comprises a voltage conditioning and power amplifier block 3051, a transmitter control circuit 3052, a matching network circuit 3053, a coil circuit 3054, and a wireless communication device 3055. The wireless power receiver 310B comprises a coil circuit 3101, a matching network circuit 3102, a receiver control circuit 3103, a rectifier 3104, and a wireless communication device 3105. The wireless power receiver 310B transmits at least one of voltage/current/power information associated with wireless power receiver 310B and/or battery 320B to the wireless power transmitter 305B via out-band wireless communication. For example, the voltage/current/power information associated with battery 320B may be sensed and transmitted to the wireless power receiver 315B via the power conditioning circuit 325B, and then the wireless power receiver 315B transmits/transfers the sensed voltage/current/power information to the wireless power transmitter 305B by using a specific frequency band other than a resonance band of wireless power transmission. Specifically, exchanging voltage/current/power information between wireless power transmitter 305B and wireless power receiver 315B can be executed by the wireless communication devices 3055 and 3105 via the specific frequency band. After receiving the voltage/current/power information, the wireless communication device 3055 transfers the received voltage/current/power information to the transmitter control circuit 3052, and the transmitter control circuit 3052 accordingly controls the voltage conditioning and power amplifier block 3051 so as to adjust the output power of wireless power transmitter 305B. By exchanging voltage/current/power information between wireless power transmitter 305B and wireless power receiver 315B via out-band wireless communication, the output power of wireless power transmitter 305B can be appropriately adjusted. The out-band wireless communication may be implemented by using Bluetooth, Zigbee, WLAN, and/or NFC communication; however, other implementations are not intended to be limitation(s) of the invention.

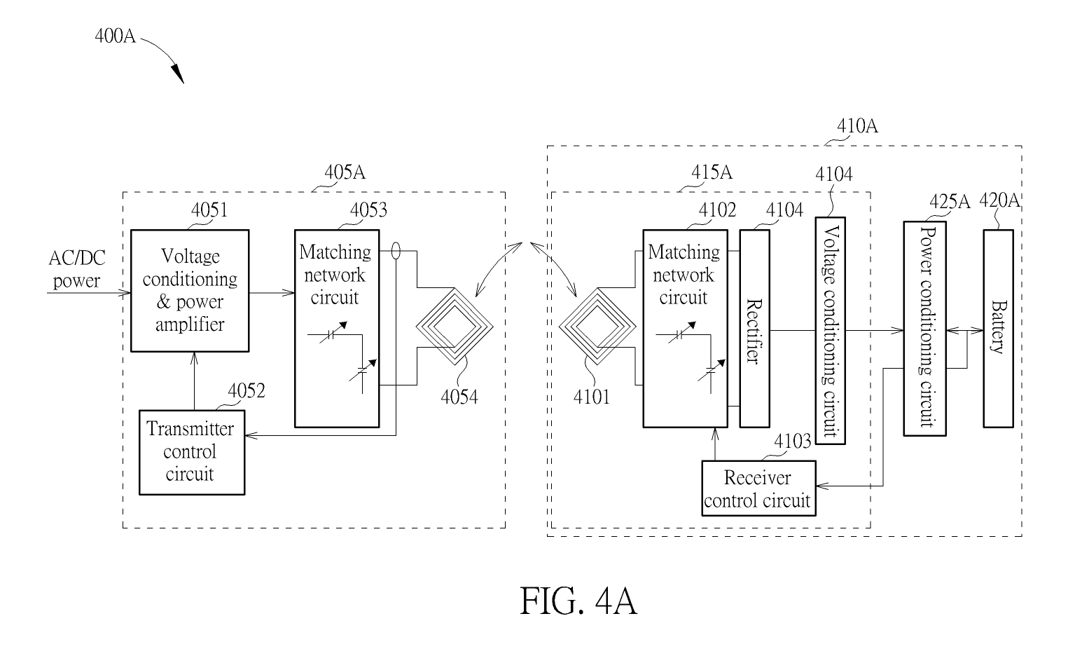

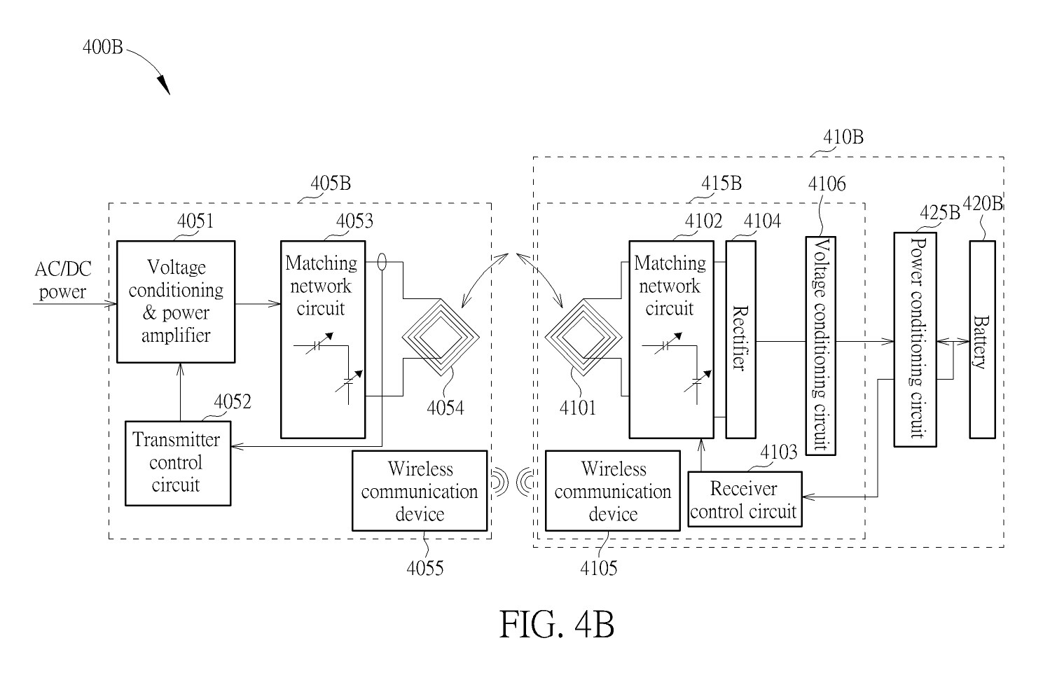

In addition, in some embodiments, a wireless power receiver may further include a voltage conditioning circuit. Please refer to FIG. 4A and FIG. 4B, which are block diagrams of wireless power supplying system 400A and 400B according to the fifth and sixth embodiments of the invention. As shown in FIG. 4A and FIG. 4B, the voltage conditioning circuits 4106 are installed within the wireless power receivers 415A and 415B, and are respectively coupled between the rectifier 4104 and power conditioning circuit 425A and coupled between the rectifier 4104 and power conditioning circuit 425B. The wireless power receiver 415A is arranged to transmit at least one of voltage/current/power information associated with wireless power receiver 415A, power conditioning circuit 425A, and battery 420A to the wireless power transmitter 405A via in-band wireless communication. The wireless power receiver 415B is arranged to transmit at least one of voltage/current/power information associated with wireless power receiver 415B, power conditioning circuit 425B, and battery 420B to the wireless power transmitter 405B via out-band wireless communication.

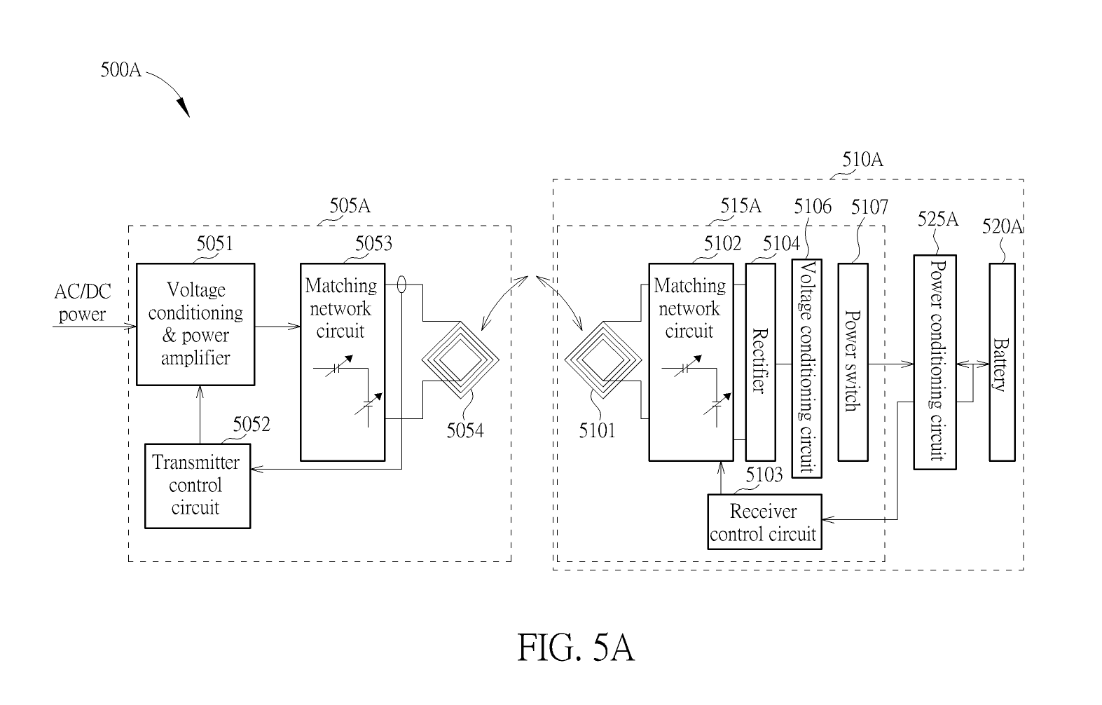

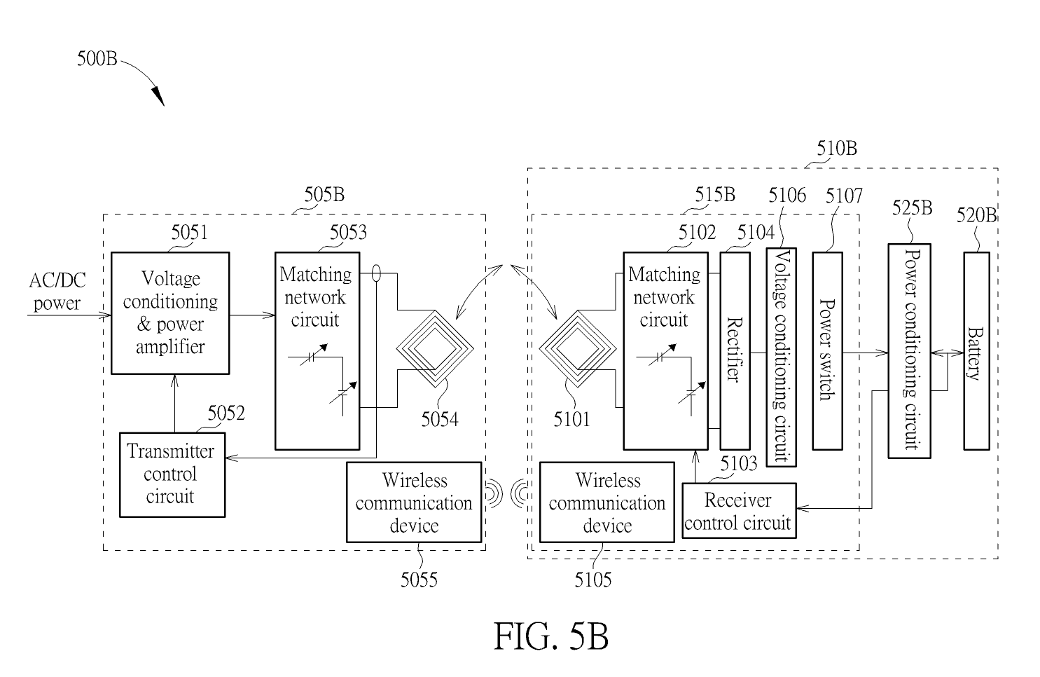

In addition, in some embodiments, a wireless power receiver may further include a power switch. Please refer to FIG. 5A and FIG. 5B, which are block diagrams of wireless power supplying system 500A and 500B according to the seventh and eighth embodiments of the invention. As shown in FIG. 5A and FIG. 5B, the power switches 5107 are disposed and coupled between the voltage conditioning circuit 5106 and power conditioning circuit 525A and coupled between the voltage conditioning circuit 5106 and power conditioning circuit 525B. The wireless power receiver 515A is arranged to transmit at least one of voltage/current/power information associated with the wireless power receiver 515A, power conditioning circuit 525A, and battery 520A to the wireless power transmitter 505A via in-band wireless communication. The wireless power receiver 515B is arranged to transmit at least one of voltage/current/power information associated with the wireless power receiver 515B, power conditioning circuit 525B, and battery 520B to the wireless power transmitter 505B via out-band wireless communication.

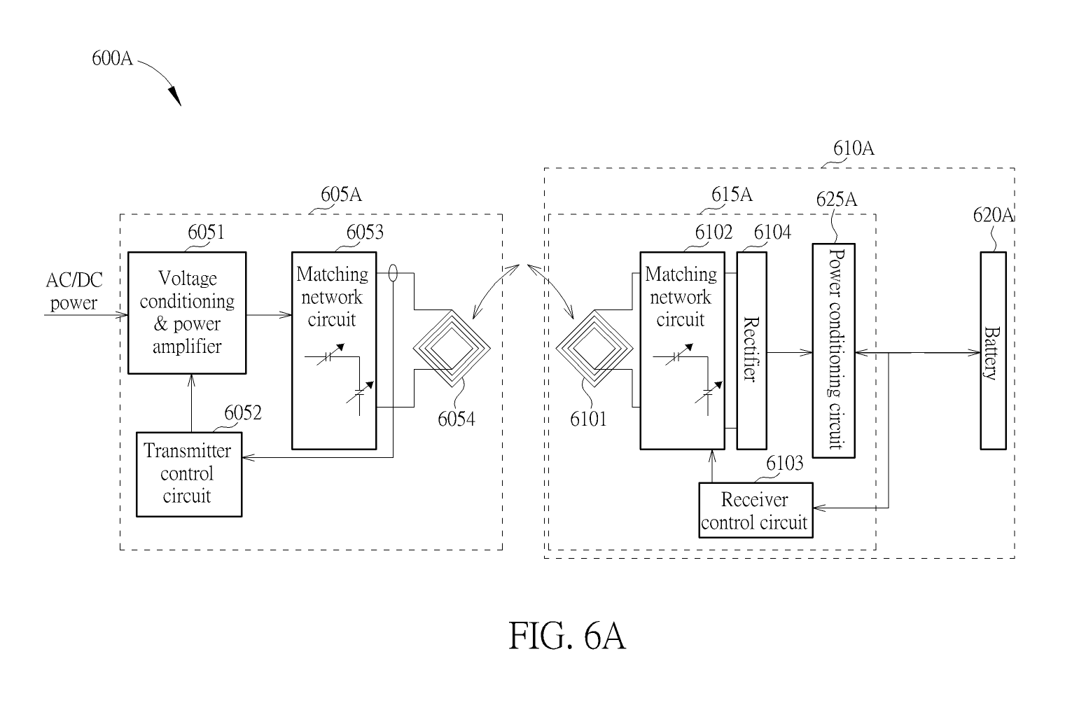

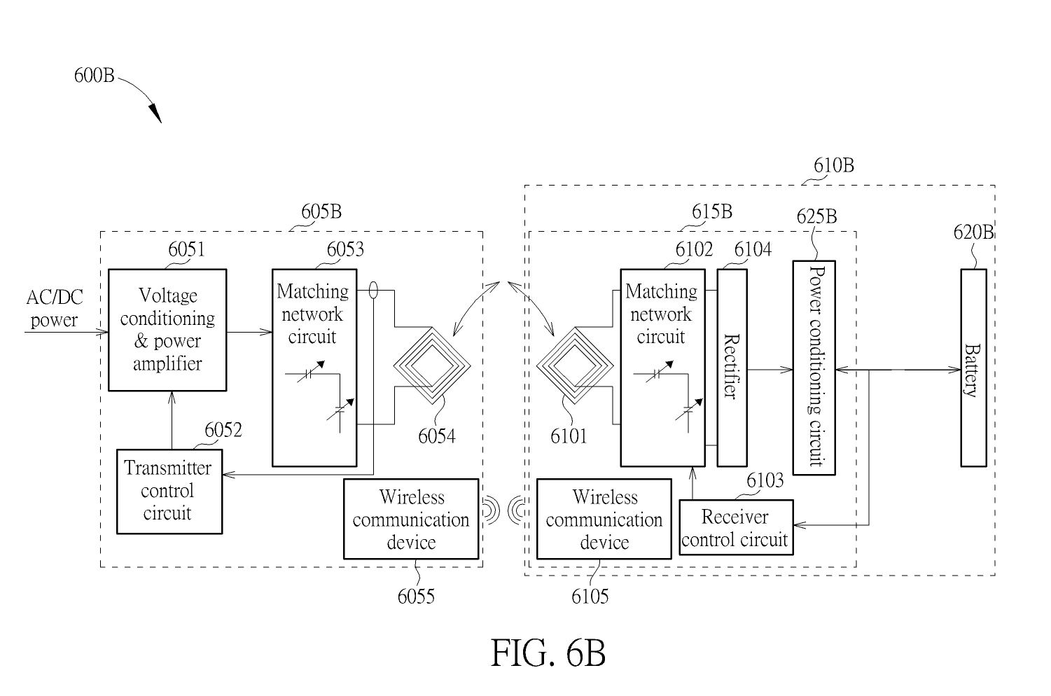

In addition, in another embodiment, a power conditioning circuit maybe disposed and installed within a wireless power receiver. That is, the power conditioning circuit is incorporated by the wireless power receiver. Please refer to FIG. 6A, which is a block diagram of a wireless power supplying system 600A according to a ninth embodiment of the invention. As shown in FIG. 6A, the power conditioning circuit 625A is installed within the wireless power receiver 615A. The wireless power receiver 615A is arranged to transmit at least one of voltage/current/power information associated with wireless power receiver 615A and/or the battery 620A from the wireless power receiver 615A back to the wireless power transmitter 605A via in-band wireless communication. For example, the voltage/current/power information associated with battery 620A may be sensed and transmitted to the wireless power receiver 615A, and then the wireless power receiver 615A transmits/transfers the sensed voltage/current/power information to the wireless power transmitter 605A by using a signal having a frequency used in wireless power transmission between wireless power transmitter 605A and wireless power receiver 615A. The transmitter control circuit 6052 detects or senses the voltage/current/power information and accordingly controls the voltage conditioning and power amplifier block 6051 so as to adjust the output power of wireless power transmitter 605A. By exchanging voltage/current/power information between wireless power transmitter 605A and wireless power receiver 615A via in-band wireless communication, the output power of wireless power transmitter 605A can be appropriately adjusted.

Please refer to FIG. 6B, which is a block diagram of a wireless power supplying system 600B according to a tenth embodiment of the invention. As shown in FIG. 6B, the power conditioning circuit 625B is installed within the wireless power receiver 615B. The wireless power receiver 615B is arranged to transmit at least one of voltage/current/power information associated with wireless power receiver 615B and/or battery 620B from the wireless power receiver 615B back to the wireless power transmitter 605B via out-band wireless communication. For example, the voltage/current/power information associated with battery 620B may be sensed and transmitted to the wireless power receiver 615B, and then the wireless power receiver 615B transmits/transfers the sensed voltage/current/power information to the wireless power transmitter 605B by using a specific frequency band other than a resonance band of wireless power transmission. The transmitter control circuit 6052 detects or senses the voltage/current/power information and accordingly controls the voltage conditioning and power amplifier block 6051 so as to adjust the output power of wireless power transmitter 605B. By exchanging voltage/current/power information between wireless power transmitter 605B and wireless power receiver 615B via out-band wireless communication, the output power of wireless power transmitter 605B can be appropriately adjusted.

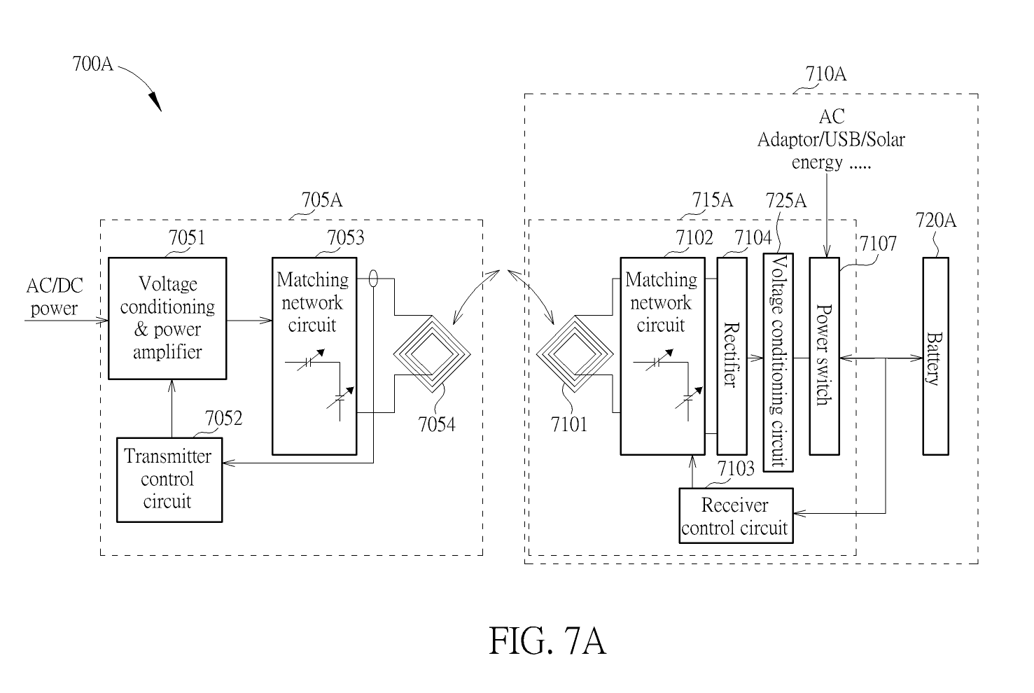

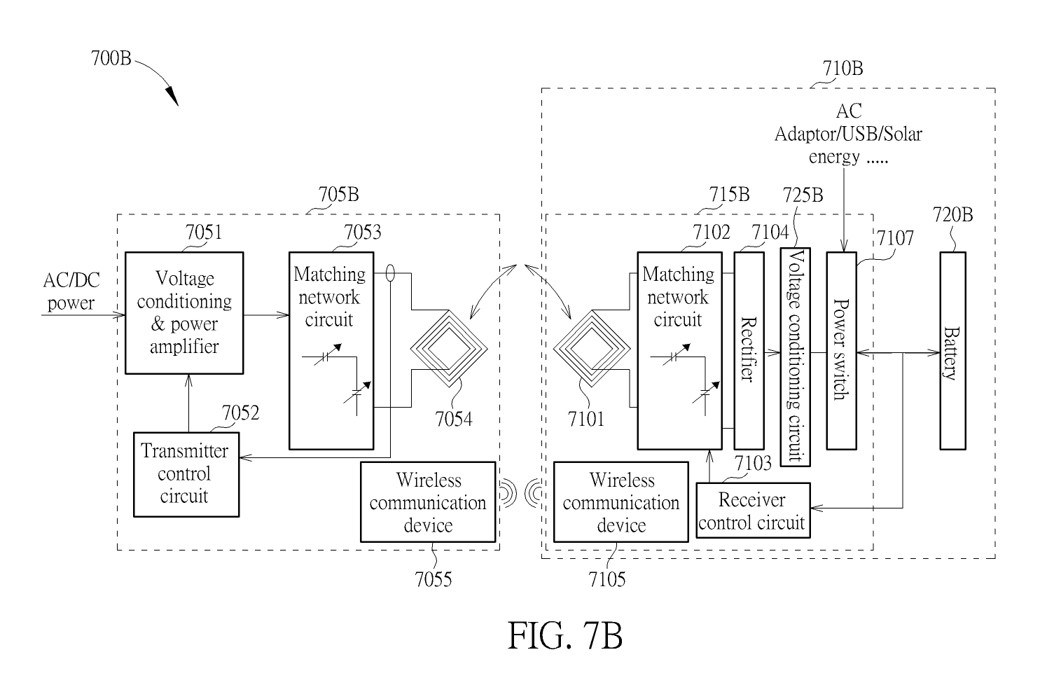

In the other embodiments, a power switch may be included within a wireless power receiver. Please refer to FIG. 7A, which is a block diagram of a wireless power supplying system 700A according to an eleventh embodiment of the invention. As shown in FIG. 7A, the power conditioning circuit 725A and the power switch 7107 are installed within the wireless power receiver 715A. The power switch 7107 is coupled between the power conditioning circuit 725A and battery 720A. The wireless power receiver 715A is arranged to transmit at least one of voltage/current/power information associated with wireless power receiver 715A and/or battery 720A from the wireless power receiver 715A back to the wireless power transmitter 705A via in-band wireless communication. For example, the voltage/current/power information associated with battery 720A may be sensed and transmitted to the wireless power receiver 715A, and then the wireless power receiver 715A transmits/transfers the sensed voltage/current/power information to the wireless power transmitter 705A by using a signal having a frequency used in wireless power transmission between wireless power transmitter 705A and wireless power receiver 715A. The transmitter control circuit 7052 detects or senses the voltage/current/power information and accordingly controls the voltage conditioning and power amplifier block 7051 so as to adjust the output power of wireless power transmitter 705A. By exchanging voltage/current/power information between wireless power transmitter 705A and wireless power receiver 715A via in-band wireless communication, the output power of wireless power transmitter 705A can be appropriately adjusted.

Please refer to FIG. 7B, which is a block diagram of a wireless power supplying system 700B according to a twelfth embodiment of the invention. As shown in FIG. 7B, the power conditioning circuit 725B and the power switch 7107 are installed within the wireless power receiver 715B. The power switch 7107 is coupled between the power conditioning circuit 725B and the battery 720B. The wireless power receiver 715B is arranged to transmit at least one of voltage/current/power information associated with the wireless power receiver 715B and/or the battery 720B from the wireless power receiver 715B back to the wireless power transmitter 705B via out-band wireless communication. For example, the voltage/current/power information associated with battery 720B may be sensed and transmitted to the wireless power receiver 715B, and then the wireless power receiver 715B transmits/transfers the sensed voltage/current/power information to the wireless power transmitter 705B by using a specific frequency band other than a resonance band of wireless power transmission. Specifically, exchanging voltage/current/power information between wireless power transmitter 705B and wireless power receiver 715B can be executed by the wireless communication devices 7055 and 7105 via the specific frequency band. After receiving the voltage/current/power information, the wireless communication device 7055 transfers the received voltage/current/power information to the transmitter control circuit 7052, and the transmitter control circuit 7052 accordingly controls the voltage conditioning and power amplifier block 7051 so as to adjust the output power of wireless power transmitter 705B. By exchanging voltage/current/power information between wireless power transmitter 705B and wireless power receiver 715B via out-band wireless communication, the output power of wireless power transmitter 705B can be appropriately adjusted. The out-band wireless communication may be implemented by using Bluetooth, Zigbee, WLAN, and/or NFC communication; however, other implementations are not intended to be limitation(s) of the invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless power supplying system, comprising:
a wireless power transmitter, for supplying an output power via wireless communication; and
a portable electronic device, electrically coupled to the wireless power transmitter, for transmitting at least one of voltage/current/power information associated with the portable electronic device from the portable electronic device back to the wireless power transmitter, so as to make the wireless power transmitter adjust and supply the output power according to the at least one of voltage/current/power information associated with the portable electronic device.

2. The wireless power supplying system of claim 1, wherein the portable electronic device comprises a wireless power receiver for receiving the output power of the wireless power transmitter and a battery coupled to the wireless power receiver; and, the at least one of voltage/current/power information transmitted by the portable electronic device is associated with at least one of the wireless power transmitter and the battery.

3. The wireless power supplying system of claim 2, wherein the portable electronic device further comprises a charger coupled between the wireless power receiver and the battery; and, the at least one of voltage/current/power information transmitted by the portable electronic device is associated with at least one of the wireless power transmitter, the charger, and the battery.

4. A method applied to a portable electronic device, comprising:
receiving an output power of a wireless power transmitter via wireless communication;
transmitting at least one of voltage/current/power information associated with the portable electronic device from the portable electronic device back to the wireless power transmitter, so as to make the wireless power transmitter adjust and supply the output power according to the at least one of voltage/current/power information associated with the portable electronic device.

5. The method of claim 4, wherein the at least one of voltage/current/power information transmitted from the portable electronic device is associated with at least one of a wireless power receiver and a battery respectively included within the portable electronic device.

6. The method of claim 5, wherein the portable electronic device further comprises a charger, and the at least one of voltage/current/power information transmitted from the portable electronic device is associated with at least one of the wireless power receiver, the charger, and the battery.

7. A method applied to a wireless power transmitter of a wireless power supplying system, comprising:
receiving at least one of voltage/current/power information from a portable electronic device sent back to the wireless power transmitter, the at least one of voltage/current/power information is associated with the portable electronic device; and
adjusting and supplying an output power of the wireless power transmitter according to the at least one of voltage/current/power information.

8. The method of claim 7, wherein the at least one of voltage/current/power information transmitted from the portable electronic device is associated with at least one of a wireless power receiver and a battery respectively included within the portable electronic device.

9. The method of claim 8, wherein the portable electronic device further comprises a charger, and the at least one of voltage/current/power information transmitted from the portable electronic device is associated with at least one of the wireless power receiver, the charger, and the battery.

10. A portable electronic device, comprising:
a wireless power receiver, for receiving an output power of a wireless power transmitter via wireless communication; and
a battery, coupled to the wireless power receiver;
wherein the wireless power receiver is arranged for transmitting at least one of voltage/current/power information associated with the portable electronic device from the wireless power receiver back to the wireless power transmitter, so as to make the wireless power transmitter adjust and supply the output power according to the at least one of voltage/current/power information.

11. The portable electronic device of claim 10, wherein the at least one of voltage/current/power information transmitted from the portable electronic device is associated with at least one of a wireless power receiver and a battery respectively included within the portable electronic device.

12. The portable electronic device of claim 11, wherein the portable electronic device further comprises a charger, and the at least one of voltage/current/power information transmitted from the portable electronic device is associated with at least one of the wireless power receiver, the charger, and the battery.

13. A wireless power transmitter of a wireless power supplying system, comprising:
a receiving circuit, for receiving at least one of voltage/current/power information from a portable electronic device sent back to the wireless power transmitter, the at least one of voltage/current/power information is associated with the portable electronic device; and
a power outputting circuit, coupled to the receiving circuit, for adjusting and supplying an output power according to the at least one of voltage/current/power information associated with the portable electronic device.

14. The wireless power transmitter of claim 13, wherein the at least one of voltage/current/power information transmitted from the portable electronic device is associated with at least one of a wireless power receiver and a battery respectively included within the portable electronic device.

15. The wireless power transmitter of claim 14, wherein the portable electronic device further comprises a charger, and the at least one of voltage/current/power information transmitted from the portable electronic device is associated with at least one of the wireless power receiver, the charger, and the battery.
